(19) United States
(12) Patent Application Publication
(10) Pub. No.: US 2026/0103161 A1
(43) Pub. Date: Apr. 16, 2026

(54) APPARATUS AND METHOD FOR DETERMINING VEHICLE COLLISION

(71) Applicants: Hyundai Motor Company, Seoul (KR); Kia Corporation, Seoul (KR)

(72) Inventor: Dae Han CHOI, Hwaseong-Si (KR)

(21) Appl. No.: 19/356,534

(22) Filed: Oct. 13, 2025

(30) Foreign Application Priority Data
Oct. 16, 2024 (KR) 10-2024-0141123

(51) Int. Cl. B60R 21/0136

(52) U.S. Cl. CPC B60R 21/0136

(57) ABSTRACT

The present disclosure relates to an apparatus and method for determining a vehicle collision. The apparatus for determining a vehicle collision may include a communication interface unit, one or more processors, and a memory configured to store one or more programs executed by the one or more processors, in which, upon receiving a collision signal indicating that a collision accident occurs in a vehicle from an airbag control circuit through a communication channel, the processor determines that the collision accident is a first collision, and determines whether an additional collision occurs after the first collision based on at least one of a collision direction and acceleration periodically received from the airbag control circuit.

### CROSS-REFERENCE TO RELATED APPLICATION

This application claims the benefit of priority to Korean Patent Application No. 10-2024-0141123, filed in the Korean Intellectual Property Office on Oct. 16, 2024, the disclosure of which is incorporated herein by reference in its entirety.

### TECHNICAL FIELD

The present disclosure relates to an apparatus and method for determining a vehicle collision, and more particularly, to an apparatus and method for determining a vehicle collision which are capable of detecting collision accidents occurring at short intervals.

### BACKGROUND

In a Chinese eCall-related document distributed by the committee responsible for establishing the Accident Emergency Call System (AECS) in China, it is stated that a minimum set of data (MSD) should be recorded when at least three consecutive collisions occur in a vehicle. Currently, Europe, the Middle East and Russia, following European laws, etc., do not require N^{th} (N is a positive number greater than or equal 2) collision detection and related data storage. However, there is a high possibility that the N^{th}-order collision detection and related data storage will be required when laws are enacted in the future.

When a collision occurred, an airbag control unit (ACU) may continuously output a collision signal of 1, and even if a second collision occurred thereafter, the collision signal=1 may be continuously output. Therefore, such method has limitations in detecting more than one collision of a vehicle.

### SUMMARY

The present disclosure is directed to providing an apparatus and method for determining a vehicle collision which are capable of detecting a collision occurring in a shorter time than a repetition cycle of a pulse width modulation (PWM) waveform.

According to the present disclosure, an apparatus of a vehicle may comprise a communication interface associated with a communication channel, a processor, and a memory storing at least one instruction that, when executed by the processor communicating with the memory, is configured to cause the apparatus to obtain, via the communication channel, a collision signal from an airbag control circuit of the vehicle, wherein the collision signal indicates that the vehicle is involved in a collision accident, determine, based on the collision signal, that the collision accident is a first collision of the vehicle, and based on at least one of collision direction information of the vehicle and acceleration information of the vehicle, output a signal indicating whether an additional collision occurs after the first collision, wherein the collision direction information and the acceleration information are received periodically from the airbag control circuit.

The airbag control circuit may be configured to repeatedly transmit a pulse width modulation (PWM) waveform of a different pattern at a first cycle based on whether the collision accident occurs, and transmit the collision direction information and the acceleration information at a second cycle shorter than the first cycle. The at least one instruction, when executed by the processor communicating with the memory, may be configured to cause the apparatus to compare at least two collision directions sequentially received from the airbag control circuit to determine whether the at least two collision directions are different, and based on a determination that the at least two collision directions are different, provisionally increase a number of collisions of the vehicle.

The at least one instruction, when executed by the processor communicating with the memory, may be configured to cause the apparatus to, based on a pulse width modulation (PWM) collision waveform received from the airbag control circuit, determine the increased number of collisions to be a final value. The at least one instruction, when executed by the processor communicating with the memory, may be configured to cause the apparatus to, based on a determination that the at least two collision directions are same, compare at least two acceleration values of the vehicle sequentially received from the airbag control circuit, and based on a difference in the at least two acceleration values being greater than a threshold, provisionally increase the number of collisions of the vehicle.

The at least one instruction, when executed by the processor communicating with the memory, may be configured to cause the apparatus to, based on a pulse width modulation (PWM) collision waveform received from the airbag control circuit, determine the increased number of collisions to be a final value. The at least one instruction, when executed by the processor communicating with the memory, may be configured to cause the apparatus to, when the communication channel is in an abnormal condition and based on a pulse width modulation (PWM) collision waveform being received from the airbag control circuit, determine that the collision accident is the first collision, wherein the PWM collision waveform indicates that the collision accident has occurred, and based on a pattern of PWM waveforms received from the airbag control circuit after the first collision of the vehicle, determine whether an additional collision has occurred after the first collision. The at least one instruction, when executed by the processor communicating with the memory, may be configured to cause the apparatus to, after the first collision of the vehicle is determined, determine that the additional collision occurs based on receiving a PWM normal waveform at least for a predetermined period of time and subsequently receiving a PWM collision waveform for the predetermined period of time.

According to the present disclosure, a method performed by an apparatus of a vehicle may comprise obtaining, via a communication channel of the vehicle, a collision signal from an airbag control circuit of the vehicle, wherein the collision signal indicates that the vehicle is involved in a collision accident; determining, based on the collision signal, that the collision accident is a first collision of the vehicle; and based on at least one of collision direction information of the vehicle and acceleration information of the vehicle, outputting a signal indicating whether an additional collision occurs after the first collision, wherein the collision direction information and the acceleration information are periodically received from the airbag control circuit.

According to the present disclosure, a vehicle may comprise an airbag control circuit, a communication interface associated with a communication channel, a processor, and a memory storing at least one instruction that, when executed by the processor communicating with the memory, is configured to cause the vehicle to obtain, from the airbag control circuit via the communication channel, a collision signal and collision direction information, determine, based on the collision signal, that a first collision of the vehicle has occurred, compare at least two pieces of collision direction information sequentially received from the airbag control circuit, determine, based on the comparison of the at least two pieces of collision direction information, whether a change in collision direction of the vehicle has occurred, based on a determination that a change in collision direction has occurred, increase a quantity of collisions of the vehicle, based on a determination that a change in collision direction has not occurred and based on a change in acceleration of the vehicle exceeding a threshold, increase the quantity of collisions of the vehicle, based on a pulse-width modulation collision waveform received from the airbag control circuit, set the increased quantity of collisions of the vehicle as a final quantity of collisions of the vehicle, and output a signal indicating the final quantity of collisions.

The at least one instruction, when executed by the processor communicating with the memory, may be configured to cause the vehicle to receive the collision direction information at intervals shorter than a cycle at which the pulse-width modulation collision waveform is repeatedly transmitted. The at least one instruction, when executed by the processor communicating with the memory, may be configured to cause the vehicle to receive, from the airbag control circuit, acceleration information at intervals shorter than a cycle at which the pulse-width modulation collision waveform is repeatedly transmitted, and determine, based on the acceleration information, the change in acceleration of the vehicle exceeds the threshold. The at least one instruction, when executed by the processor communicating with the memory, may be configured to cause the vehicle to generate a set of collision data comprising at least one of a quantity of collisions of the vehicle, a collision direction of the vehicle, or a time associated with an airbag deployment signal, and transmit the set of collision data to an emergency call server.

The features briefly summarized above with respect to the present disclosure are merely examples of the detailed description of the disclosure to be described below, and do not limit the scope of the disclosure.

### BRIEF DESCRIPTION OF DRAWINGS

The above and other objects, features and advantages of the present disclosure will become more apparent to those of ordinary skill in the art by describing examples thereof in detail with reference to the accompanying drawings, in which:

FIG. 1 shows an exemplary vehicle that determines an N^{th} collision (N is a positive number greater than or equal to 1) for an eCall service;

FIG. 2 shows an example of an airbag control unit (ACU);

FIG. 3 shows an X-axis, a Y-axis, and a Z-axis of a vehicle;

FIG. 4 shows an example of a pattern of a pulse width modulation (PWM) waveform generated when a first processor detects a collision;

FIG. 5 shows an example of a message including acceleration collected at a 10 ms cycle for 0 ms to 250 ms;

FIG. 6 shows an example of an eCall electronic device;

FIG. 7 shows an example of a method of generating and transmitting information necessary for an ACU to determine an N^{th} collision in the method of determining a vehicle collision; and

FIG. 8 shows an example of a method of an eCall electronic device to determine an N^{th} collision in the method of determining a vehicle collision.

FIG. 9 shows an example of a computing system.

### DETAILED DESCRIPTION

Hereinafter, examples of the present disclosure will be described in detail with reference to the accompanying drawings so that those skilled in the art may easily practice the present disclosure. However, the present disclosure may be implemented in various different forms and is not limited to examples described herein.

Further, in describing examples of the present disclosure, well-known functions or constructions will not be described in detail since they may unnecessarily obscure the understanding of the present disclosure. In the drawings, parts not related to the description of the present disclosure are omitted, and similar reference numerals are attached to similar parts.

In the present disclosure, when a component is said to be “connected,” “coupled,” or “joined” to another component, this may include not only a direct connection relationship, but also an indirect connection relationship where another component exists therebetween. In addition, when a component “includes” or “has” another component, this means that the component may further include other components, not excluding the inclusion of the other components unless otherwise stated.

In the present disclosure, terms such as “first” and “second” are used only for the purpose of distinguishing one component from other components, and do not limit the order, importance, or the like of components unless otherwise specified. Accordingly, within the scope of the present disclosure, a first component in an example may be referred to as a second component in another example, and similarly, a second component in an example may be referred to as a first component in other examples.

In the present disclosure, components distinguished from each other are intended to clearly explain each feature, and do not mean that the components are necessarily separated. That is, a plurality of components may be integrated to be formed in a single hardware or software unit, or a single component may be distributed to be formed in a plurality of hardware or software units. Accordingly, even when not described separately, such integrated or distributed examples are also included in the scope of the present disclosure.

In the present disclosure, components described in various examples are not necessarily essential components, and some of the components may be optional components. Therefore, examples composed of a subset of components described in an example are also included in the scope of the present disclosure. In addition, examples including other components in addition to the components described in various examples are also included in the scope of the present disclosure.

For purposes of this application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as “A, B, or C”, “at least one of A, B, and C”, “at least one of A, B, or C”, etc. as used herein may mean each listed item or all possible combinations of the listed items. For example, “at least one of A or B” may refer to (1) at least one A; (2) at least one B; or (3) at least one A and at least one B.

Various advantages and features of the present disclosure and methods accomplishing the same will become apparent from the following detailed description of examples with reference to the accompanying drawings. However, the present disclosure is not limited to examples disclosed below but may be implemented in various different forms. These examples will be provided only in order to make the disclosure of the present disclosure complete and allow those skilled in the art to which the present disclosure pertains to completely recognize the scope of the present disclosure.

The term “module” or “unit” used in the specification means a software and/or hardware component, and the “module” or “unit” performs certain operations/functions/roles. However, the “module” or “unit” is not construed as being limited to software or hardware. The “module” or “unit” may be configured to be in an addressable storage medium or to execute one or more processors. Therefore, as an example, the “module” or “unit” may include at least one of components such as software components, object-oriented software components, class components, and task components, processes, functions, attributes, procedures, sub-routines, segments of program codes, drivers, firmware, micro-codes, circuits, data, databases, data structures, tables, arrays, or variables. Functions provided in the components, “modules”, or “units” may be combined into a smaller number of components, “modules”, or “units” or further divided into additional components, “modules”, or “units”.

In the present disclosure, the “module” or “unit” may be realized as a processor and a memory. The “processor” should be widely construed to include a general-purpose processor, a central processing unit (CPU), a microprocessor, a digital signal processor (DSP), a microcontroller, a state machine, or the like. In some environments, the “processor” may refer to an application-specific integrated circuit (ASIC), a programmable logic device (PLD), or a field-programmable gate array (FPGA), and the like. For example, the “processor” may refer to a combination of processing devices such as a combination of a DSP and a microprocessor, a combination of a plurality of microprocessors, a combination of one or more microprocessors combined with a DSP core, or any other such combination. Moreover, the “memory” should be widely construed to include any electronic component capable of storing electronic information. The “memory” may refer to various types of processor-readable medium such as a random access memory (RAM), a read only memory (ROM), a non-volatile random access memory (NVRAM), a programmable read only memory (PROM), an erasable programmable read only memory (EPROM), an electrically erasable programmable read only memory (EEPROM), a flash memory, a magnetic or optical data storage device, and registers. When the processor can read information from a memory and/or record the information in the memory, the memory may be in a state of electronic communication with a processor. Memory integrated into a processor is in a state of electronic communication with the processor.

The one or more features described herein may be provided as a computer program stored in a computer-readable recording medium in order to be executed on a computer. The medium may either continuously store a computer-executable program or temporarily store the program for execution or download. Furthermore, the medium may be a variety of recording or storage means in the form of a single hardware device or multiple combined hardware devices, and is not limited to media directly connected to some computer system but may also be distributed across a network. Examples of such media include magnetic media such as a hard disk, a floppy disk, or a magnetic tape, optical recording media such as a CD-ROM or a DVD, magneto-optical media such as a floptical disk, and a ROM, RAM, or flash memory, among others, configured to store program instructions. Additional examples of such media include media or storage media that are managed by an app store that distributes applications or by various other sites or servers that provide or distribute software.

In a hardware implementation, processing units used for performing the techniques may be implemented within one or more ASICs, DSPs, digital signal processing devices, programmable logic devices, field-programmable gate arrays, processors, controllers, microcontrollers, microprocessors, electronic devices, or computers or combinations thereof designed to perform the functions described in the present disclosure.

In the present disclosure, “first collision time” may mean either the time when a collision sensor 100 first detects a collision but an airbag is not deployed, or the time when the airbag deployment signal is received from an airbag sensor 200. The airbag deployment signal is a signal indicating that the airbag has been deployed.

In the present disclosure, a “pulse width modulation (PWM) normal waveform” is a waveform indicating that the vehicle is driving normally without a collision accident and may be generated by an airbag control unit (ACU).

In the present disclosure, a “PWM collision waveform” is a waveform indicating that a collision accident has occurred and may be generated by an ACU 300.

According to the present disclosure, a vehicle collision determination apparatus and method may enable accurate detection of multiple collisions occurring in rapid succession. Other systems often output a continuous collision signal after an initial impact, making it difficult to distinguish subsequent impacts. The described approach utilizes collision direction data, acceleration data, and pulse-width modulation (PWM) waveforms transmitted from an airbag control circuit. By analyzing changes in collision direction and variations in acceleration at short intervals, the apparatus may detect additional collisions and confirm the additional collisions when corresponding PWM signals are received. This allows detection of collisions occurring at intervals shorter than the PWM cycle and supports generation of detailed accident information, including the number of collisions, directions, and timing, which may be transmitted to an emergency call (eCall) service to improve accident assessment and rescue response.

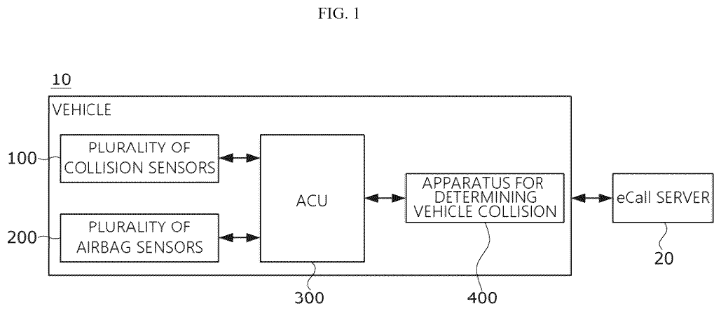

FIG. 1 shows an exemplary vehicle 10 that determines an N^{th} collision (Nis a positive number greater than or equal to 1) for an eCall service according to an example of the present disclosure.

Referring to FIG. 1, the vehicle 10 for determining an N^{th} collision of a vehicle for an eCall service according to the example of the present disclosure may include a plurality of collision sensors 100, a plurality of airbag sensors 200, an ACU 300, and an apparatus 400 for determining a vehicle collision. In the description of the present disclosure, the plurality of collision sensors 100 and the plurality of airbag sensors 200 are illustrated separately from the ACU 300, but the plurality of collision sensors 100 and the plurality of airbag sensors 200 may be included in the ACU 300. The apparatus 400 for determining a vehicle collision may be an electronic control device having an eCall function (e.g., a telematics control unit, a connected car service controller, or a standalone crash-detection ECU, etc.).

The plurality of collision sensors 100 may be distributed and installed outside the vehicle 10 to detect collision information when a collision accident occurs and transmit the detected collision information to the ACU 300. The collision information may include the intensity or direction of the collision and the identification information of the collision sensor that detects the collision. The plurality of collision sensors 100 may be installed, for example, at front bumpers, rear bumpers, side doors, or roof pillars (e.g., A-pillars, B-pillars, or C-pillars, etc.). The collision information may further include time information at which the collision was detected, and if the time information is not included, the time at which the ACU 300 receives the collision information may be determined as the time the collision was detected.

The plurality of airbag sensors 200 may be installed at a location where an airbag module is installed in the vehicle 10 to detect whether the airbag is deployed and may transmit an airbag deployment signal to the ACU 300 when the airbag of the airbag module is deployed. The airbag module is a module that includes an airbag, and may be installed on a steering wheel, a dashboard, a seat, a car door, or a side curtain area (e.g., roof rails, side panels, or knee bolsters, etc.). When N airbag modules are installed in the vehicle 10, at least N airbag sensors 200 are also installed, and when some of the N airbags are deployed, some of the corresponding airbag sensors may transmit the airbag deployment signal.

The ACU 300 may be an electronic control unit (ECU) that monitors the collision situation of the vehicle 10 and determines whether to deploy the airbag (e.g., front airbag, side airbag, curtain airbag, or knee airbag, etc.). The ACU 300 may receive the collision information from at least one of the plurality of collision sensors 100, determine whether to deploy the airbag, and transmit an airbag deployment command to the airbag module. In addition, when the ACU 300 receives the airbag deployment signal from the airbag sensor 200, the ACU 300 may transmit the airbag deployment signal, a collision direction (e.g., front impact, rear impact, or side impact, etc.), acceleration (e.g., variations in accelerations, longitudinal acceleration, lateral acceleration, or vertical acceleration, etc.), and a PWM waveform (e.g., a normal waveform, a collision waveform, or a diagnostic waveform, etc.) to the apparatus 400 for determining a vehicle collision.

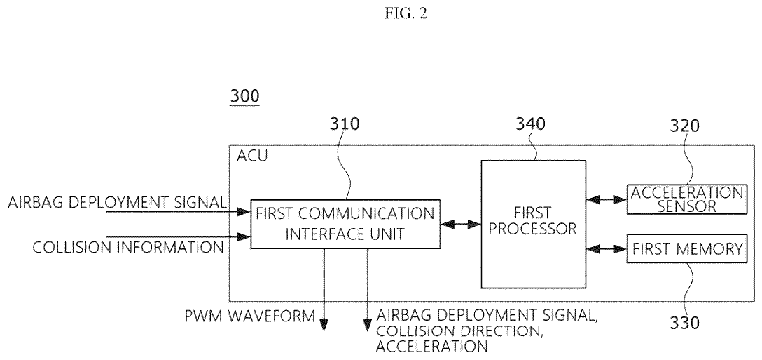

FIG. 2 is a block diagram illustrating the ACU 300 according to an example of the present disclosure.

Referring to FIG. 2, the ACU 300 according to an example of the present disclosure may include a first communication interface unit 310, an acceleration sensor 320, a first memory 330, and a first processor 340.

The first communication interface unit 310 may be configured to communicate with the plurality of collision sensors 100, the plurality of airbag sensors 200, and the apparatus 400 for determining a vehicle collision.

The first communication interface unit 310 may transmit and receive controller area network (CAN) signals using a communication channel with the ECU and a CAN mounted on the vehicle 10 as well as the apparatus 400 for determining a vehicle collision. The CAN communication channel may be a communication bus using a CAN protocol (e.g., CAN-FD, LIN bus, FlexRay, or Ethernet, etc.).

The first communication interface unit 310 may receive the airbag deployment signal from the airbag sensor 200 through the communication channel, receive the collision information from the collision sensor 100, and transmit the airbag deployment signal, the collision information, and the acceleration to the apparatus 400 for determining a vehicle collision.

In addition, the first communication interface unit 310 may repeatedly transmit a PWM normal waveform or a PWM collision waveform to the apparatus 400 for determining a vehicle collision through a digital signal line at a certain cycle (e.g., every 1 second, every 500 ms, or every 100 ms, etc.).

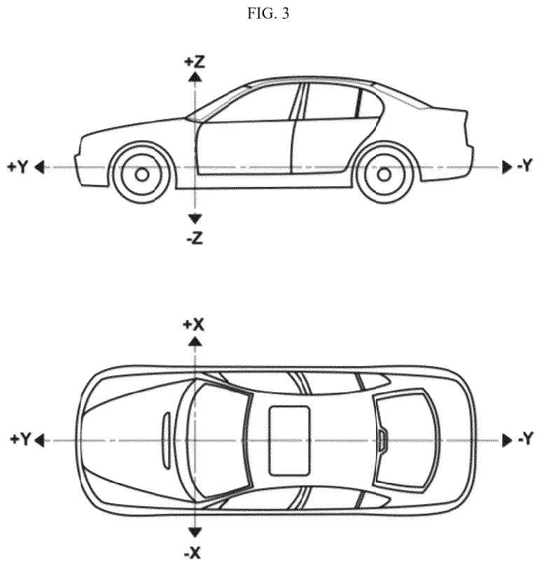

The acceleration sensor 320 may periodically detect an X-axis acceleration and a Y-axis acceleration of the vehicle 10. The acceleration sensor 320 may detect acceleration at a cycle of 10 ms, for example (e.g., 5 ms, 20 ms, or 50 ms, etc.). FIG. 3 is a diagram illustrating the X-axis, Y-axis, and Z-axis of the vehicle 10.

The first memory 330 stores at least one program (e.g., an operating system, application software, firmware, middleware, or diagnostic software, etc.), various data, and at least one command to implement or provide an operation or function provided by the ACU 300, and loads programs, reads or records data, or performs an operation corresponding to the command at the request of the first processor 340.

The program stored in the first memory 330 may include an information processing program that collects information necessary to determine an N^{th} (N is a positive number greater than or equal to 1) collision of the vehicle 10 and transmits the collected information to the apparatus 400 for determining a vehicle collision. The information processing program may include a command that generates a collision message using the collision information (e.g., sensor ID, impact direction, or impact magnitude, etc.) received from at least one of a plurality of collision sensors 100, generates an acceleration message using the acceleration (e.g., X-axis, Y-axis, or Z-axis acceleration values, etc.) received from the acceleration sensor 320, and generates the PWM waveform (e.g., a normal waveform, a collision waveform, etc.) by analyzing at least one of the collision information and the acceleration.

The first memory 330 may include at least one of a main memory device and an auxiliary memory device. The main memory device may be implemented using semiconductor storage media, such as a read only memory (ROM) and/or random access memory (RAM), and the auxiliary memory may be implemented based on a device capable of permanently or semi-permanently storing data, such as a flash memory device (e.g., a solid state drive (SSD), a secure digital (SD) card, or an embedded multimedia card (eMMC), etc.), a secure digital (SD) card, a hard disk drive (HDD), a compact disc, a digital versatile disc (DVD), or a laser disc.

The first processor 340 controls the overall operation of the ACU 300 by executing one or more operating systems or programs stored in the first memory 330. The first processor 340 may include, for example, a CPU, a graphics processing unit (GPU), a micro controller unit (MCU), an application processor (AP), or at least one electronic device capable of performing various operations and control processing. These devices may be implemented by using, for example, one or more semiconductor chips, circuits, or related components, alone or in combination. In addition, the first processor 340 may load commands or data received from other components (e.g., the acceleration sensor 320 or the first communication interface unit 310, or a gyro sensor, etc.) into a volatile memory, process the commands or data stored in the volatile memory, and store the processing results in a nonvolatile memory.

In an example of the present disclosure, the first processor 340 may execute an information processing program to collect information necessary for determining an N^{th} collision and process the collected information to be transmitted to the apparatus 400 for determining a vehicle collision. The information necessary for determining an N^{th} collision may include the airbag deployment signal, the PWM waveform, the collision direction, and the acceleration, and the PWM waveform may include the PWM normal waveform and the PWM collision waveform (e.g., transmitted in alternating 1-second intervals, shorter intervals, or longer intervals, etc.).

In detail, the first processor 340 may analyze a value detected by at least one of the collision sensor 100, the acceleration sensor 320, and the gyro sensor (not shown) to generate the PWM waveform (i.e., the PWM normal waveform or the PWM collision waveform) (e.g., a square wave, a pulse train, or a varying duty cycle pattern, etc.) and transmit the generated PWM waveform to the apparatus 400 for determining a vehicle collision. Alternatively, the first processor 340 may not transmit the PWM normal waveform and may transmit only the PWM collision waveform to the apparatus 400 for determining a vehicle collision. The first processor 340 may generate the PWM normal waveform before the airbag deployment signal is received and generate the PWM collision waveform when the airbag deployment signal is received. The first processor 340 may repeatedly transmit a PWM waveform of a different pattern at a certain cycle depending on whether the vehicle 10 has a collision accident.

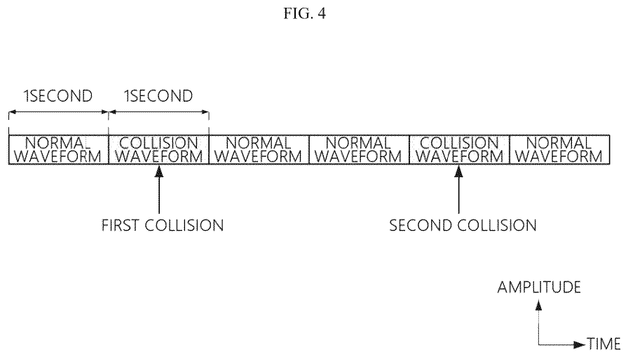

FIG. 4 shows an example of a pattern of a PWM waveform generated when the first processor 340 detects a collision.

Referring to FIG. 4, the first processor 340 repeatedly transmits the PWM normal waveform at a certain cycle. The first processor 340 may repeatedly transmit the PWM normal waveform at a cycle of, for example, 1 second, and when the collision occurs, transmit the PWM collision waveform for 1 second and then repeatedly transmit the PWM normal waveform for 1 second or more. Thereafter, when a second collision occurs, the first processor 340 may again transmit the PWM collision waveform for 1 second and then repeatedly transmit the PWM normal waveform for 1 second or more. Here, 1 second may be increased or decreased, for example (e.g., 0.5 seconds, 2 seconds, or 5 seconds, etc.).

Referring to FIG. 4, because the first processor 340 should transmit the PWM waveform for at least 2 seconds (i.e., 1 second of the PWM collision waveform and 1 second of the PWM normal waveform) whenever a collision is detected, the apparatus 400 for determining a vehicle collision may have difficulty detecting consecutive collisions occurring within 2 seconds. To this end, the first processor 340 may transmit the collision direction and the acceleration at a shorter cycle (e.g., 5 ms, 10 ms, or 20 ms, etc.) than the certain cycle (1 second in the case of FIG. 4) at which the PWM waveform is repeatedly transmitted.

To this end, the first processor 340 may store the received collision information in the first memory 330 when the collision information is received from at least one of the plurality of collision sensors 100.

In addition, the first processor 340 stores the X-axis acceleration and Y-axis acceleration periodically detected by the acceleration sensor 320 in the first memory 330.

When the airbag deployment signal is received from the airbag sensor 200, the first processor 340 may generate the collision message using the first collision information detected at the time when the airbag deployment signal is received. For example, when the first processor 340 analyzes the received collision information, acceleration, and gyro sensing values (e.g., yaw rate, roll rate, or pitch rate, etc.), and determines that the airbag deployment is necessary, the first processor 340 may transmit a command to the airbag module to deploy the airbag within several tens of ms after the collision information is received. Therefore, when the time when the airbag deployment signal is received and the time when the first collision information is detected are within a preset error range (e.g., 5 ms, 10 ms, or 20 ms, etc.), it may be determined that the first collision information is detected at the time when the airbag deployment signal is received.

The first processor 340 may generate the collision message every certain cycle (e.g., 10 ms, 20 ms, or 50 ms, etc.) and transmit the generated collision message to the apparatus 400 for determining a vehicle collision. 10 ms is an example and may be increased or decreased by a manager.

[Table 1] shows an example of the collision message generated by the first processor 340 using the collision information received from the collision sensor 100.

TABLE 1

| Collision information (collision data) | | | MSD | |
|---|---|---|---|---|
| Message | Signal | Value Table | Item | Value |
| ACU_02_00_ms | ACU_Crsh | xxxx xxxxB: No | Location | 1(none) |
| | Typ | deployment Crash | Of Impact | |
| | | xxxx xxx1B: Front | | 2(Front impact) |
| | | Crash (First stage only) | | |
| | | xxxx xx1xB: Front | | 2(Front impact) |
| | | Crash (Full stage) | | |
| | | 1xxx xxxxB: Rear Crash | | 3(Rear impact) |
| | | xxxx x1xxB: Side Crash | | 4(Driver side |
| | | (Driver side) | | impact) |
| | | xxxx 1xxxB: Side Crash | | 5(nonDriverSide) |
| | | (Passenger side) | | |
| | | X1xx xxxxB: Side | NA | NA |
| | | Crash Detection For | | |
| | | Door Unlock (NON- | | |
| | | SAB vehicle) | | |
| | | Xxx1 xxxxB: Rollover | rolloverDetected | True |
| | | Crash (Restraints | | |
| | | activation) | | |
| | | Xx1x xxxxB: Rollover | | True |
| | | event information | | |
| | | transmission (Restraints | | |
| | | non-activation) | | |

In [Table 1], the message is the name of the collision message generated by the first processor 340 and may include the information on the time when the collision was detected (e.g., 0 ms, 10 ms, or 20 ms, etc.).

ACU_CrshTyp@ACU_02_00 ms is an example of a collision message. ACU_02_00 ms is a message name that includes the collision information detected at 0 ms when the time when the first collision was detected is set to 0 ms. For example, the first processor 340 may write a message including the collision information at a 10 ms cycle, and a message generated when 10 ms have elapsed from the time when the collision occurs may have the name of ACU_02_10 ms (e.g., ACU_02_20 ms, ACU_02_30 ms, or ACU_02_40 ms, etc.). The signal indicates that the message being transmitted is the collision message and may include a collision code of a value table.

The value is a code indicating the collision direction, a basic code without a collision has the form of xxxx xxxxB, and when the collision is detected in the corresponding collision direction, a digit corresponding to the collision direction among 8 digits is changed to 1. Therefore, the collision direction may be known from the collision code. For example, when a collision sensor located on a side of a driver's seat detects a collision, ACU_CrashTyp may include a collision code of xxxx x1xxB (e.g., indicating a left-side impact, driver-side T-bone, or similar event, etc.). When the collision information is not received from the collision sensor 100 after 10 ms have elapsed, the first processor 340 may generate a collision message including xxxx xxxxB to indicate that the collision direction has not changed (e.g., no front, side, or rear collision detected, etc.).

In addition, when the airbag deployment signal is received from the airbag sensor 200, the first processor 340 may generate the acceleration message using the acceleration corresponding to the time when the airbag deployment signal is received. For example, the first processor 340 may generate the acceleration message using the acceleration detected at the same time as or closest to the time when the airbag deployment signal is received. The closest time may be one of the values detected after the airbag deployment signal is received and the values detected before the airbag deployment signal is received (e.g., +10 ms, +20 ms, or +30 ms, etc.).

[Table 2] shows an example of the acceleration message generated by the first processor 340.

TABLE 2

| Acceleration data | | MSD item | |
|---|---|---|---|
| Message | Signal | Item | Value |
| ACU_DVx_01_00_ms | ACU_DVx_250 ms | deltaVx | −100~100 |
| ACU_DVy_01_00_ms | ACU_DVy_250 ms | deltaVy | −100~100 |

In [Table 2], the acceleration message may include the time when the acceleration was detected. ACU_DVx_250 ms@ACU_DVx_01_00 ms is an example of an X-axis acceleration message, and ACU_DVy_7_250 ms@ACU_DVy_01_00 ms is an example of a Y-axis acceleration message. DVx is the X-axis acceleration of the vehicle 10, and DVy is the Y-axis acceleration of the vehicle 10 (e.g., DVx for forward/rearward movement and DVy for lateral movement, etc.). In the case of ACU_DVx_01_00_ms, when the time when the airbag deployment signal is introduced is set to 0 ms, it means that the message includes the X-axis acceleration detected at 0 ms. ACU_DVx_250 ms is the X-axis acceleration detected when 250 ms have elapsed since 0 ms (e.g., at 250 ms, 500 ms, or 750 ms, etc.).

For example, when an initial collision is detected or the airbag deployment signal is received, the first processor 340 may collect acceleration for 250 ms to generate the acceleration message and then transmit the collected acceleration to the apparatus 400 for determining a vehicle collision and transmit the collected acceleration at 500 ms intervals thereafter (e.g., at 500 ms, 1000 ms, or 1500 ms, etc.). The message may include the acceleration detected at 10 ms intervals from 0 ms to 250 ms (e.g., at 10 ms, 20 ms, or 30 ms, etc.). That is, the first processor 340 may collect acceleration detected at 10 ms intervals for 250 ms after the first collision is detected at 0 ms, then transmit the collected acceleration at 250 ms, and then transmit the acceleration every 500 ms thereafter. 10 ms, 250 ms, and 500 ms are examples and are not limited thereto and may be increased or decreased (e.g., 20 ms, 300 ms, or 600 ms, etc.).

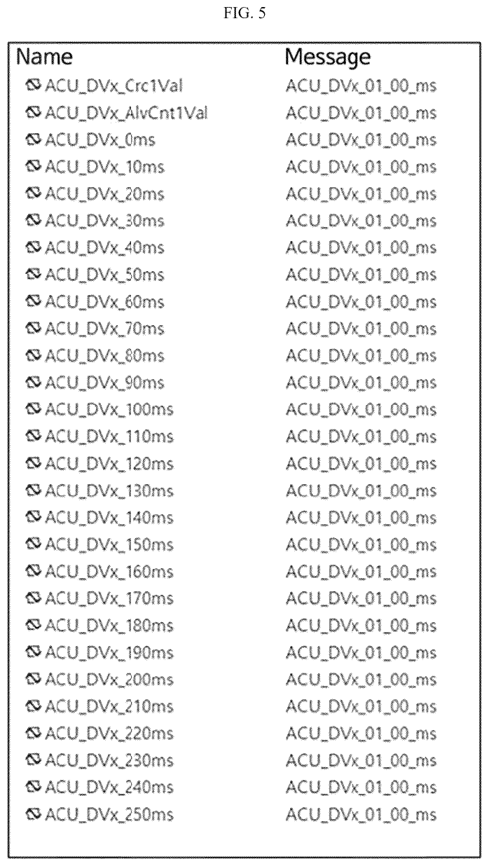

FIG. 5 shows an example of a message including acceleration collected at a 10 ms cycle for 0 ms to 250 ms.

Referring to FIG. 5, the first processor 340 may generate a message including X-axis acceleration detected 26 times from 0 ms to 250 ms and transmit the generated message to the apparatus 400 for determining a vehicle collision (e.g., samples at 0 ms, 10 ms, 20 ms . . . up to 250 ms, etc.).

When the CAN communication is normal, the first processor 340 transmits the collision message and the acceleration message that are initially generated after the airbag deployment signal is received, and transmits the airbag deployment signal to the apparatus 400 for determining a vehicle collision through the communication channel. Thereafter, the first processor 340 may generate the collision message and the acceleration message at each set cycle and transmit the generated collision message and acceleration message to the apparatus 400 for determining a vehicle collision. The transmission cycles of the collision message and the acceleration message may be the same or different (e.g., both at 500 ms, or collision at 250 ms and acceleration at 500 ms, etc.).

In addition, the first processor 340 may transmit the PWM collision waveform for 1 second and transmit the PWM normal waveform for 1 second or more when the CAN communication is abnormal (e.g., 1-2 seconds of collision waveform followed by 2-3 seconds of normal waveform, etc.).

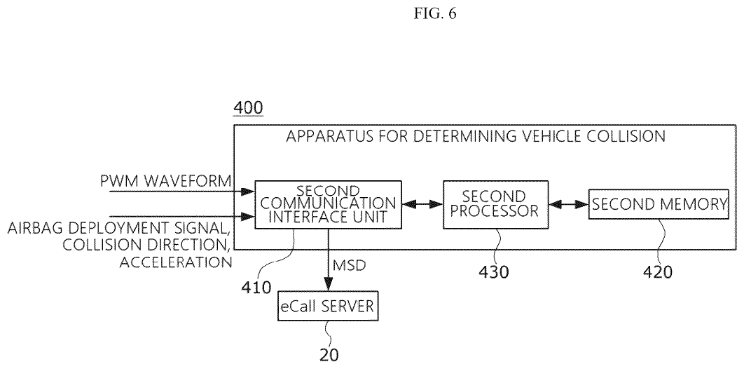

FIG. 6 is a block diagram illustrating the apparatus 400 for determining a vehicle collision according to an example of the present disclosure.

Referring to FIG. 6, the apparatus 400 for determining a vehicle collision according to an example of the present disclosure may include a second communication interface unit 410, a second memory 420, and a second processor 430.

The second communication interface unit 410 may be configured to communicate with the ACU 300 and the eCall server 20 via wired or wireless communication. The eCall server 20 may be a connected car service (CCS) server or an emergency rescue center for providing an eCall service (e.g., an OnStar system, a government-operated 911 dispatch center, or a private emergency response provider, etc.). In addition, the second communication interface unit 410 may communicate with the ECU mounted on the vehicle 10 as well as the ACU 300.

The second communication interface unit 410 may receive the airbag deployment signal, the collision message including the collision direction, and the acceleration message including the acceleration from the ACU 300 via the communication channel. Hereinafter, for convenience of explanation, the collision message is referred to as the collision direction, and the acceleration message is referred to as the acceleration.

The second communication interface unit 410 may receive the PWM waveform (e.g., a square waveform, triangular waveform, or sawtooth waveform, etc.) as in FIG. 4 from the ACU 300 via a digital signal line.

The second communication interface unit 410 may generate a minimum set of data (MSD) to the eCall server 20 to transmit the N^{th} collision information.

In addition, when the vehicle 10 is a vehicle that has subscribed to the CCS, the second communication interface unit 410 may communicate with the CCS server (not illustrated) through a network (not illustrated) via the wired or wireless means. The eCall server 20 may be the CCS server. The second communication interface unit 410 may communicate based on Long Term Evolution (LTE), a 5th generation (5G) communication network, Wireless Fidelity (WiFi), Wireless Access in Vehicular Environment (WAVE) communication, Dedicated Short Range Communication (DSRC), short-range communication, Bluetooth, or satellite-based vehicle telematics communication (e.g., Iridium, Starlink, or Inmarsat, etc.).

The second memory 420 stores at least one program, various data, and at least one command to implement or provide an operation or function provided by the apparatus 400 for determining a vehicle collision. The configuration of the second memory 420 is similar or identical to that of the first memory 330, and therefore a detailed description thereof will be omitted.

The program stored in the second memory 420 may include a collision program that determines the N^{th} collision of the vehicle 10. The collision program may include a command for determining the N^{th} collision using at least one of the airbag deployment signal, the collision direction, the acceleration, and the PWM waveform (e.g., only the collision direction and acceleration, or only the PWM waveform when CAN is abnormal, etc.).

The second processor 430 executes the program stored in the second memory 420 to control the overall operation of the apparatus 400 for determining a vehicle collision. Because the second processor 430 is similar or identical to the first processor 340, a detailed description thereof will be omitted.

In an example of the present disclosure, the second processor 430 may execute the collision program to distinguish between the normal and abnormal cases of the CAN communication and determine the N^{th} collision.

First, the configuration of the second processor 430 that determines the N^{th} collision when the CAN communication is normal will be described.

When the CAN communication is normal, the second processor 430 may determine that the first collision has occurred when a collision signal indicating that a collision accident has occurred in the vehicle 10 is received from the ACU 300 through the communication channel (N=1). The collision signal is the airbag deployment signal transmitted from the ACU 300 when the airbag is deployed and may have a Crash output=1 format (e.g., a digital high-level signal of 5 V or 3.3 V representing the airbag deployment event).

After the first collision, the second processor 430 may determine whether an additional collision has occurred based on at least one of the collision direction and the acceleration periodically received from the ACU 300. In this case, the cycle at which the collision direction or the acceleration is received may be shorter than a certain cycle at which the PWM waveform is repeated (e.g., the collision direction may update every 10 ms, the acceleration may update every 250-500 ms, while the PWM waveform repeats at about 1 second). For example, the collision direction may be received every 10 ms, the acceleration may be received every 250 ms at first and every 500 ms thereafter, and the PWM waveform may be received at a length of 1 second (e.g., 1 Hz cycle time, though longer cycles such as 2 Hz or shorter cycles such as 0.5 Hz may also be possible, etc.).

The second processor 430 may compare at least two collision directions sequentially and periodically received from the ACU 300 to determine whether the collision direction has changed, and when it is determined that the collision direction has changed, may temporarily increase the number of collisions of the vehicle 10 (Ntemp=2).

On the other hand, when it is determined that the collision direction has not changed as a result of comparing at least two collision directions, the second processor 430 compares at least two accelerations sequentially and periodically received from the ACU 300. When the amount of change in the acceleration is greater than a predetermined acceleration threshold, the second processor 430 may temporarily increase the number of collisions of the vehicle 10 (Ntemp=2). When at least one of the amount of change in the X-axis acceleration or the amount of change in the Y-axis acceleration is greater than the acceleration threshold, the second processor 430 may temporarily increase the number of collisions.

For example, the acceleration thresholds may be 30 kph for both the X-axis threshold and the Y-axis threshold, which may be increased or decreased. The maximum acceleration that may occur during normal driving is approximately 20 kph, so it is obvious that the acceleration threshold may be set to 30 kph (e.g., thresholds may alternatively be 25 kph, 35 kph, or a dynamic threshold calculated from prior driving patterns, etc.) but is not limited thereto.

The second processor 430 may determine the temporarily increased number of collisions (Ntemp=2) as the actual number of collisions (N=2) when the PWM collision waveform is received from the ACU 300 after the number of collisions of the vehicle 10 is temporarily increased (Ntemp=2). In this case, the received PWM collision waveform is a waveform generated by an additional collision that occurred within 2 seconds after the first collision was detected and may serve to confirm once again that the additional collision has occurred (e.g., a secondary rear impact following a front impact, or a side impact following a rollover, etc.).

Next, the configuration of the second processor 430 that determines the N^{th} collision when the CAN communication is abnormal will be described.

The second processor 430 may determine that the first collision has occurred when the PWM collision waveform is received from the ACU 300 through the signal line when the CAN communication is abnormal (N=1). After it is determined that the collision accident is the first collision, the second processor 430 may determine that the additional collision has occurred when the PWM normal waveform is received for a predetermined period of time (e.g., 1 second) or longer and then the PWM collision waveform is received again for a predetermined period of time (e.g., 1 second) (e.g., 2 seconds of normal followed by 1 second of collision, or 1.5 seconds of normal followed by 1 second of collision, etc.) (N=2).

The second processor 430 may create the MSD related to the collision of the vehicle and store the created MSD in the second memory 420. The MSD may include the information related to the vehicle collision, such as the number of collisions, the collision direction, and the time when the airbag deployment signal is generated (e.g., N=3, rear impact, 120 ms after airbag deployment, etc.).

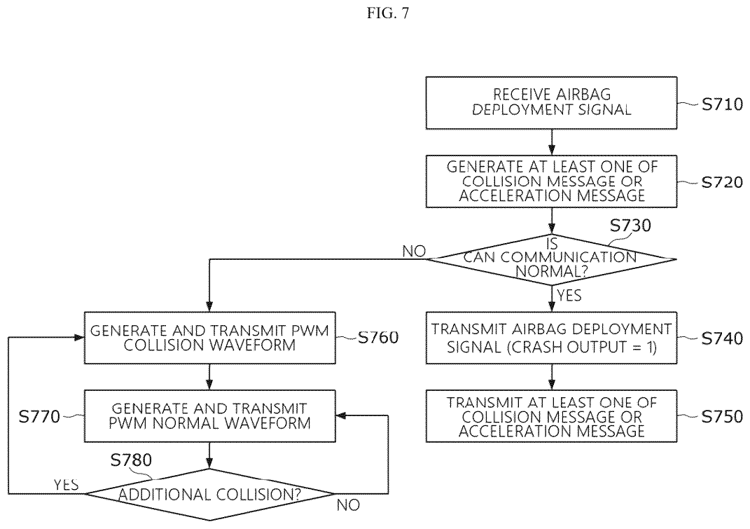

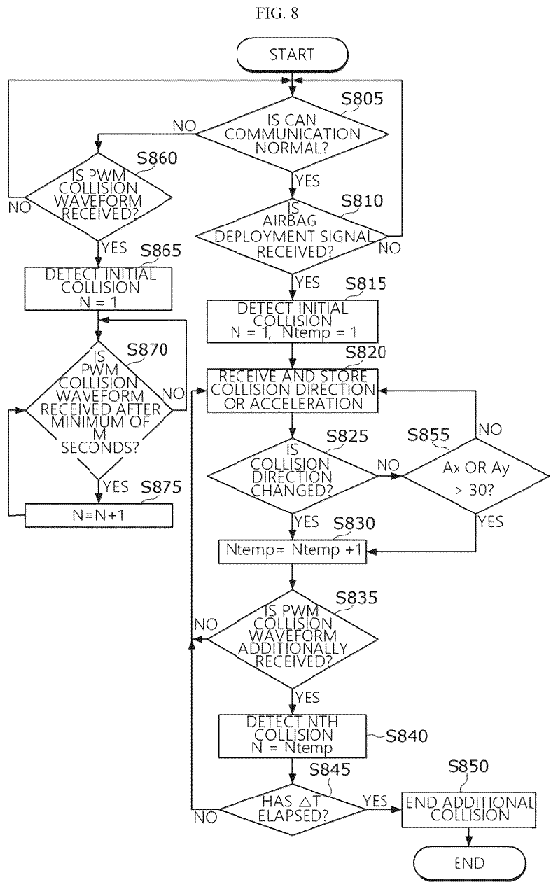

Hereinafter, a method of determining a vehicle collision according to an example of the present disclosure will be described with reference to FIGS. 7 and 8.

FIG. 7 shows an example of a method of generating and transmitting information necessary for the ACU 300 to determine the N^{th} collision in the method of determining a vehicle collision according to the example of the present disclosure.

Referring to FIG. 7, when the ACU 300 receives the airbag deployment signal from the airbag sensor 200 (S710), the ACU 300 may generate the collision message based on the collision information received from at least one of the plurality of collision sensors 100, and may generate the acceleration message based on the acceleration detected by the acceleration sensor 320 (S720).

In operation S720, since the plurality of collision sensors 100 transmit the collision information whenever the collision is detected, the ACU 300 may generate the collision message periodically (for example, every 10 ms) regardless of whether the collision information is received. In addition, since the acceleration sensor 320 detects the acceleration of the vehicle 10 periodically (for example, every 10 ms), the ACU 300 may collect the acceleration input from the acceleration sensor 320 every 10 ms for a certain period of time (e.g., 250 ms immediately after the initial collision, and then 500 ms thereafter) and then generate the acceleration message. For example, when the airbag deployment signal is received, the ACU 300 may initially generate the acceleration message using the acceleration collected every 10 ms for 250 ms and then generate the acceleration message using the acceleration collected every 10 ms for 500 ms. The acceleration message is based on short-term collection (250 ms) immediately after deployment and long-term collection (500 ms) afterward.

When the CAN communication is normal (S730—Yes), the ACU 300 may transmit Crash output=1 to the apparatus 400 for determining a vehicle collision (S740). The Crash output is the CAN signal transmitted from the ACU 300 when the airbag is deployed (e.g., the CAN signal indicating airbag deployment).

Along with the airbag deployment signal, the ACU 300 may transmit at least one of the collision message and the acceleration message to the apparatus 400 for determining a vehicle collision (S750). The ACU 300 may also perform operations S740 and S750 simultaneously (e.g., transmitting Crash output=1 while simultaneously sending acceleration data or collision direction data).

On the other hand, when the CAN communication is abnormal (S730—No), the ACU 300 may generate the PWM collision waveform of 1 second in length and the PWM normal waveform of 1 second or longer and transmit the generated PWM collision waveform and PWM normal waveform to the apparatus 400 for determining a vehicle collision (S760 and S770). For example, the PWM collision waveform may be generated at 1-second intervals, while the PWM normal waveform may continue for 2 seconds, 3 seconds, or longer, depending on system settings.

When the additional collision occurs at least 2 seconds after the initial collision has occurred (S780—Yes), the ACU 300 may perform operation S760 of generating and transmitting the PWM collision waveform (e.g., a second impact to the rear of the vehicle occurring 2-3 seconds after an initial frontal impact).

On the other hand, when an additional collision does not occur after at least 2 seconds (S780—No), the ACU 300 may perform operation S770 of generating and transmitting the PWM normal waveform (e.g., continuing to output a steady PWM signal for 2, 4, or 5 seconds in the absence of further impact).

FIG. 8 shows an example of a method of determining, by the apparatus 400 for determining a vehicle collision, an N^{th} collision in the method of determining a vehicle collision according to the example of the present disclosure.

Referring to FIG. 8, when the CAN communication is normal (S805) and when the apparatus 400 receives the airbag deployment signal (e.g., Crash output=1) through the communication channel (S810-Y), it is determined that the initial collision has occurred and N=1 and Ntemp=1 (S815). N is the confirmed number of collisions and Ntemp is the temporary number of collisions.

After the first collision, the apparatus 400 stores the collision direction or the acceleration periodically received from the ACU 300 (S820). The collision direction or the acceleration may be received together with the airbag deployment signal in operation S810 (e.g., acceleration data collected every 10 ms or collision direction data indicating front, side, or rear impact).

The apparatus 400 compares the stored collision direction with the pre-stored collision direction, and when the collision direction has changed (S825-Y), the apparatus 400 may temporarily increase the number of collisions of the vehicle 10 (Ntemp=2) (S830). For example, the collision direction may change from front to side, side to rear, or left to right, indicating a multi-directional crash. In the case of the first received collision direction (S825-N), there is no comparison target, so it may proceed to operation S855.

After the number of collisions of the vehicle 10 is temporarily increased (Ntemp=2), when the PWM collision waveform is received from the ACU 300 (S835—Y), the apparatus 400 may set the temporarily increased number of collisions (Ntemp=2) in operation S830 as the actual number of collisions (N=2) (S840). In this case, the received PWM collision waveform is a waveform generated by an additional collision that occurred within 2 seconds after the first collision was detected and may serve to confirm once again that the additional collision has occurred (e.g., a rear-end collision following an initial frontal impact within 2 seconds, or a side collision occurring immediately after the first crash).

When it is determined that the second collision has occurred in operation S840, the apparatus 400 determines that collision accidents will no longer occur after a preset time (ΔT) has elapsed after the airbag deployment signal is received (S850) (e.g., ΔT may be set to 2 seconds, 5 seconds, or 10 seconds depending on system requirements).

On the other hand, when the PWM collision waveform is not received in operation S835 (S835—N), the apparatus 400 performs operation S820.

When it is determined that the collision direction has not changed in operation S825 (S825—N) or the time (ΔT) set in operation S845 has not elapsed, the apparatus 400 compares at least two accelerations that are sequentially received from the ACU 300 and stored (S855).

In operation S855, when at least one of Ax (absolute value of change in the X-axis acceleration) or Ay (absolute value of change in the Y-axis acceleration) is greater than the acceleration threshold (S855—Y), the apparatus 400 may temporarily increase the number of collisions (Ntemp=2) (S830). The acceleration threshold is 30, which can be changed (e.g., adjusted to 20, 40, or 50 depending on vehicle type, crash test data, or safety standards).

Then, the apparatus 400 performs operations S835 to S850.

In addition, when the CAN communication is abnormal in operation S805 (S805-N) and when the apparatus 400 receives the PWM collision waveform from the ACU 300 through the signal line (S860-Y), it may be determined that the first collision has occurred (N=1) (S865). After operation S860, the apparatus 400 may receive the PWM normal waveform for 1 second or more (e.g., 1.5 seconds, 2 seconds, or 3 seconds, etc.).

When it is determined that the vehicle collision is the first collision and the PWM collision waveform is received after at least m seconds (m is 2, for example) (S870-Y), the apparatus 400 may determine that the additional collision has occurred (N=2) (S875). For example, after the PWM collision waveform of 1 second is received in operation S860, when the PWM normal waveform of more than 1 second (e.g., 1.5 seconds or 2 seconds) is received and then the PWM collision waveform is received again, the apparatus 400 may determine that the additional collision has occurred (e.g., a second rear-end collision after an initial frontal collision, or a side impact after a rollover).

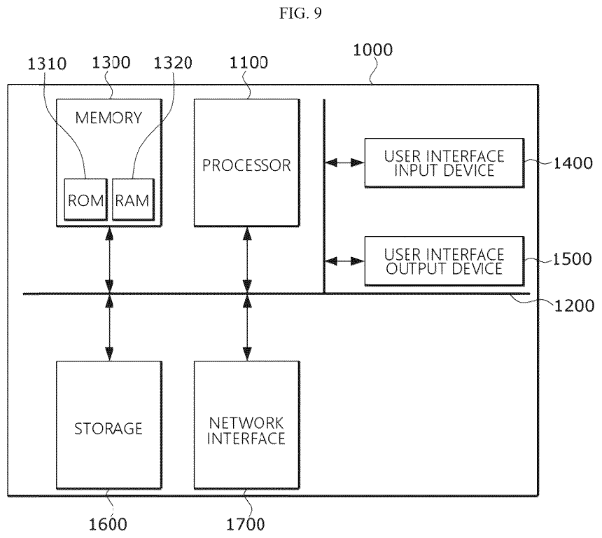

FIG. 9 shows an example computing system (e.g., a computing device of a vehicle or any other apparatus). One or more controllers, processors, etc. described herein, such as one or more components of the vehicle 100 and any other components and devices disclosed herein, may be implemented by or in the computing system as shown in FIG. 9. A computing system 1000 may include at least one processor 1100, memory 1300, a user interface input device 1400, a user interface output device 1500, a storage 1600, and a network interface 1700, which are connected with each other via a bus 1200.

The processor 1100 may be a central processing unit (CPU) or a semiconductor device that processes instructions stored in the memory 1300 and/or the storage 1600. Each of the memory 1300 and the storage 1600 may include various types of volatile or nonvolatile storage media. For example, the memory 1300 may include a read-only memory (ROM) and a random-access memory (RAM).

Communication interface(s) (also referred to as communication device(s), communicator(s), communication module(s), communication unit(s), etc.), such as the network interface 1700, may allow software and/or data to be transferred between a device and one or more external devices, and/or between one or more components of a device. Communication interface(s) may include a receiver, a transmitter, a transceiver, a modem, a network interface and/or adapter (such as an Ethernet adapter), a radio transceiver, an antenna, a communication port, a Personal Computer Memory Card International Association (PCMCIA) slot and card, or the like. Software and data transferred via communication interface(s) may be in the form of signals, which may be electronic, electromagnetic, optical, infrared, or other signals capable of being received by communication interface(s). These signals may be provided to communication interface(s) via a communication path of a device, which may be implemented using, for example, wire or cable, fiber optics, a cellular link, a radio frequency (RF) link and/or other communications channels. Communication interface(s) may communicate using one or more communication protocols, such as Ethernet, Wi-Fi, near-field communication (NFC), Infrared Data Association (IrDA), Bluetooth, Bluetooth low energy (BLE), Zigbee, Long-Term Evolution (LTE), 5G New Radio (NR), vehicle-to-everything (V2X), a controller area network (CAN), or a local interconnect network (LIN), etc.

Accordingly, the operations of the method or algorithm described in connection with example example(s) disclosed in the specification may be directly implemented with a hardware module, a software module, or a combination of the hardware module and the software module, which is executed by the processor 1100. The software module may reside on a storage medium (e.g., the memory 1300 and/or the storage 1600) such as RAM, a flash memory, ROM, an erasable and programmable ROM (EPROM), an electrically EPROM (EEPROM), a register, a hard disk drive, a removable disc, or a compact disc-ROM (CD-ROM).

The storage medium may be coupled to the processor 1100. The processor 1100 may read out information from the storage medium and may write information in the storage medium. Alternatively, the storage medium may be integrated with the processor 1100. The processor and storage medium may be implemented with an application specific integrated circuit (ASIC). The ASIC may be provided in a user terminal. Alternatively, the processor and storage medium may be implemented with separate components in the user terminal.

According to an example of the present disclosure, there is provided an apparatus for determining a vehicle collision, including: a communication interface unit; one or more processors; and a memory configured to store one or more programs executed by the one or more processors, in which, upon receiving a collision signal indicating that a collision accident occurs in a vehicle from an airbag control unit (ACU) through a communication channel, the processor determines that the collision accident is a first collision, and determines whether an additional collision occurs after the first collision based on at least one of a collision direction and acceleration periodically received from the ACU.

The ACU may repeatedly transmit a PWM waveform of a different pattern at a certain cycle depending on whether the collision accident occurs in the vehicle, and transmit the collision direction and acceleration at a shorter cycle than the certain cycle at which the PWM waveform is repeated.

The processor may compare at least two collision directions sequentially received from the ACU to determine whether the collision direction changes, and when it is determined that the collision direction changes, temporarily increases the number of collisions of the vehicle.

When the number of collisions of the vehicle is temporarily increased and then the PWM collision waveform is received from the ACU, the processor determines the temporarily increased number of collisions as the actual number of collisions.

When it is determined that the collision direction does not change as a result of comparing the at least two collision directions, the processor may compare at least two accelerations sequentially received from the ACU, and when an amount of change in acceleration is greater than a threshold, the processor may temporarily increase the number of collisions of the vehicle.

When the number of collisions of the vehicle is temporarily increased and then the PWM collision waveform is received from the ACU, the processor may determine the temporarily increased number of collisions as the actual number of collisions.

When the PWM collision waveform indicating that the collision accident occurs from the ACU due to abnormality of the communication channel is received, the processor may determine that the collision accident is the first collision, and after it is determined that the collision accident is the first collision, determine whether an additional collision occurs after the first collision based on a pattern of the PWM waveform received from the ACU.

After it is determined that the collision accident is the first collision, when a PWM normal waveform is received for a predetermined period of time or longer and then the PWM collision waveform is received for the predetermined period of time, the processor may determine that the additional collision occurs.

According to another example of the present disclosure, there is provided a method of determining a vehicle collision, which is performed by an apparatus including a memory configured to store one or more programs executed by one or more processors, including: upon receiving a collision signal indicating that a collision accident occurs in a vehicle from an ACU through a communication channel, determining that the collision accident is a first collision; and determining whether an additional collision occurs after the first collision based on at least one of a collision direction and acceleration periodically received from the ACU.

The ACU may repeatedly transmit a PWM waveform of a different pattern at a certain cycle depending on whether the collision accident occurs in the vehicle, and transmit the collision direction and acceleration at a shorter cycle than the certain cycle at which the PWM waveform is repeated.

The determining of whether the additional collision occurs may include: comparing at least two collision directions sequentially received from the ACU to determine whether the collision direction changes; and temporarily increasing the number of collisions of the vehicle when it is determined that the collision direction changes.

The determining of whether the additional collision occurs may further include determining the temporarily increased number of collisions of the vehicle as the actual number of collisions when the number of collisions of the vehicle is temporarily increased and the PWM collision waveform is received from the ACU.

The determining of whether the additional collision occurs may include: calculating an amount of change in acceleration by comparing at least two accelerations sequentially received from the ACU when it is determined that the collision direction does not change as a result of comparing the at least two collision directions; and temporarily increasing the number of collisions of the vehicle when the calculated amount of change in acceleration is greater than a threshold.

The determining of whether the additional collision occurs may further include determining the temporarily increased number of collisions of the vehicle as the actual number of collisions when the number of collisions of the vehicle is temporarily increased and the PWM collision waveform is received from the ACU.

The apparatus may further include: when the PWM collision waveform indicating that the collision accident occurs from the ACU due to abnormality of the communication channel is received, determining that the collision accident is the first collision; and after it is determined that the collision accident is the first collision, determining whether an additional collision occurs after the first collision based on a pattern of the PWM waveform received from the ACU.

In the determining of whether the additional collision occurs, after it is determined that the collision accident is the first collision, when a PWM normal waveform is received for a predetermined period of time or longer and then the PWM collision waveform is received for the predetermined period of time, it may be determined that the additional collision occurs.

Various examples of the present disclosure are intended to explain representative examples of the present disclosure, rather than listing all possible combinations, and matters described in various examples may be applied independently or in combinations of two or more.

In addition, various examples of the present disclosure may be implemented by hardware, firmware, software, a combination thereof, or the like. For implementation by hardware, various examples of the present disclosure may be implemented by one or more application specific integrated circuits (ASICs), digital signal processors (DSPs), digital signal processing devices (DSPDs), programmable logic devices (PLDs), field programmable gate arrays (FPGAs), processors, controllers, microcontrollers, microprocessors, or the like.

According to the present disclosure, when the PWM waveform is repeatedly transmitted at a certain cycle, the collision that occurs in a shorter time than the certain cycle of the PWM cycle can be detected, thereby more accurately detecting and determining the second or later collisions.

In addition, according to the present disclosure, the MSD including the information on the second or later collisions can be created and transmitted to the eCall server, thereby inferring the accident situation and preparing the rescue method in advance.

The scope of the present disclosure includes software or machine-executable instructions (e.g., operating systems, applications, firmware, programs, etc.) that cause operations according to the methods of various examples to be executed on a device or computer, and a non-transitory computer-readable medium in which such software, instructions, etc., are stored and executable on a device or computer.

What is claimed is:

1. An apparatus of a vehicle, the apparatus comprising:
a communication interface associated with a communication channel;
a processor; and
a memory storing at least one instruction that, when executed by the processor communicating with the memory, is configured to cause the apparatus to:
obtain, via the communication channel, a collision signal from an airbag control circuit of the vehicle, wherein the collision signal indicates that the vehicle is involved in a collision accident,
determine, based on the collision signal, that the collision accident is a first collision of the vehicle, and
based on at least one of collision direction information of the vehicle and acceleration information of the vehicle, output a signal indicating whether an additional collision occurs after the first collision, wherein the collision direction information and the acceleration information are received periodically from the airbag control circuit.

2. The apparatus of claim 1, wherein the airbag control circuit is configured to:
repeatedly transmit a pulse width modulation (PWM) waveform of a different pattern at a first cycle based on whether the collision accident occurs, and
transmit the collision direction information and the acceleration information at a second cycle shorter than the first cycle.

3. The apparatus of claim 1, wherein the at least one instruction, when executed by the processor communicating with the memory, is configured to cause the apparatus to:
compare at least two collision directions sequentially received from the airbag control circuit to determine whether the at least two collision directions are different, and
based on a determination that the at least two collision directions are different, provisionally increase a number of collisions of the vehicle.

4. The apparatus of claim 3, wherein, the at least one instruction, when executed by the processor communicating with the memory, is configured to cause the apparatus to, based on a pulse width modulation (PWM) collision waveform received from the airbag control circuit, determine the increased number of collisions to be a final value.

5. The apparatus of claim 3, wherein the at least one instruction, when executed by the processor communicating with the memory, is configured to cause the apparatus to, based on a determination that the at least two collision directions are same:
compare at least two acceleration values of the vehicle sequentially received from the airbag control circuit, and
based on a difference in the at least two acceleration values being greater than a threshold, provisionally increase the number of collisions of the vehicle.

6. The apparatus of claim 5, wherein, based on a pulse width modulation (PWM) collision waveform received from the airbag control circuit, the at least one instruction, when executed by the processor communicating with the memory, is configured to cause the apparatus to determine the increased number of collisions to be a final value.

7. The apparatus of claim 1, wherein the at least one instruction, when executed by the processor communicating with the memory, is configured to cause the apparatus to:
when the communication channel is in an abnormal condition and based on a pulse width modulation (PWM) collision waveform being received from the airbag control circuit, determine that the collision accident is the first collision, wherein the PWM collision waveform indicates that the collision accident has occurred, and
based on a pattern of PWM waveforms received from the airbag control circuit after the first collision of the vehicle, determine whether an additional collision has occurred after the first collision.

8. The apparatus of claim 7, wherein, after the first collision of the vehicle is determined, the at least one instruction, when executed by the processor communicating with the memory, is configured to cause the apparatus to determine that the additional collision occurs based on receiving a PWM normal waveform at least for a predetermined period of time and subsequently receiving a PWM collision waveform for the predetermined period of time.

9. A method performed by an apparatus of a vehicle, the method comprising:
obtaining, via a communication channel of the vehicle, a collision signal from an airbag control circuit of the vehicle, wherein the collision signal indicates that the vehicle is involved in a collision accident;
determining, based on the collision signal, that the collision accident is a first collision of the vehicle; and
based on at least one of collision direction information of the vehicle and acceleration information of the vehicle, outputting a signal indicating whether an additional collision occurs after the first collision, wherein the collision direction information and the acceleration information are periodically received from the airbag control circuit.

10. The method of claim 9, further comprising:
repeatedly transmitting, by the airbag control circuit, a pulse width modulation (PWM) waveform of a different pattern at a first cycle based on whether the collision accident occurs; and
transmitting the collision direction information and the acceleration information at a second cycle shorter than the first cycle.

11. The method of claim 9, wherein the determining of whether the additional collision occurs comprises:
comparing at least two collision directions sequentially received from the airbag control circuit to determine whether the at least two collision directions are different; and
based on a determination that the at least two collision directions are different, provisionally increasing a number of collisions of the vehicle.

12. The method of claim 11, wherein the determining of whether the additional collision occurs further comprises, based on a pulse width modulation (PWM) collision waveform received from the airbag control circuit, determining the increased number of collisions of the vehicle to be a final value.

13. The method of claim 11, wherein the determining of whether the additional collision occurs comprises, based on a determination that the at least two collision directions are same:
comparing at least two accelerations values of the vehicle sequentially received from the airbag control circuit; and
based on a difference in the at least two acceleration values being greater than a threshold, provisionally increasing the number of collisions of the vehicle.

14. The method of claim 13, wherein the determining of whether the additional collision occurs further comprises: based on a pulse width modulation (PWM) collision waveform received from the airbag control circuit, determining the increased number of collisions of the vehicle to be a final value.

15. The method of claim 9, further comprising:
when the communication channel is in an abnormal condition and based on a pulse width modulation (PWM) collision waveform being received from the airbag control circuit, determining that the collision accident is the first collision; and
based on a pattern of PWM waveforms received from the airbag control circuit after the first collision of the vehicle, determining whether an additional collision occurs after the first collision.

16. The method of claim 15, wherein the determining of whether the additional collision occurs comprises, after the first collision is determined, determining that the additional collision occurs based on receiving a PWM normal waveform at least for a predetermined period of time and subsequently receiving a PWM collision waveform for the predetermined period of time.

17. A vehicle comprising:
an airbag control circuit;
a communication interface associated with a communication channel;
a processor; and
a memory storing at least one instruction that, when executed by the processor communicating with the memory, is configured to cause the vehicle to:
obtain, from the airbag control circuit via the communication channel, a collision signal and collision direction information,
determine, based on the collision signal, that a first collision of the vehicle has occurred,
compare at least two pieces of collision direction information sequentially received from the airbag control circuit,
determine, based on the comparison of the at least two pieces of collision direction information, whether a change in collision direction of the vehicle has occurred,
based on a determination that a change in collision direction has occurred, increase a quantity of collisions of the vehicle,
based on a determination that a change in collision direction has not occurred and based on a change in acceleration of the vehicle exceeding a threshold, increase the quantity of collisions of the vehicle,
based on a pulse-width modulation collision waveform received from the airbag control circuit, set the increased quantity of collisions of the vehicle as a final quantity of collisions of the vehicle, and
output a signal indicating the final quantity of collisions.

18. The vehicle of claim 17, wherein the at least one instruction, when executed by the processor communicating with the memory, is configured to cause the vehicle to receive the collision direction information at intervals shorter than a cycle at which the pulse-width modulation collision waveform is repeatedly transmitted.

19. The vehicle of claim 17, wherein the at least one instruction, when executed by the processor communicating with the memory, is configured to cause the vehicle to:
receive, from the airbag control circuit, acceleration information at intervals shorter than a cycle at which the pulse-width modulation collision waveform is repeatedly transmitted, and
determine, based on the acceleration information, the change in acceleration of the vehicle exceeds the threshold.

20. The vehicle of claim 17, wherein the at least one instruction, when executed by the processor communicating with the memory, is configured to cause the vehicle to:
generate a set of collision data comprising at least one of a quantity of collisions of the vehicle, a collision direction of the vehicle, or a time associated with an airbag deployment signal, and
transmit the set of collision data to an emergency call server.
